(19) United States
(12) Patent Application Publication
(10) Pub. No.: US 2017/0293790 A1
(43) Pub. Date: Oct. 12, 2017

(54) ELECTRONIC DEVICE, CONTROLLING METHOD THEREOF AND MANUFACTURING METHOD THEREOF

(71) Applicant: Acer Incorporated, New Taipei City (TW)

(72) Inventors: Wei-Heng Huang, New Taipei City (TW); Hsu-Hsiang Tseng, New Taipei City (TW); Chih-Chiang Chen, New Taipei City (TW)

(21) Appl. No.: 15/344,613

(22) Filed: Nov. 7, 2016

(30) Foreign Application Priority Data
Apr. 11, 2016 (TW) 105111256

(51) Int. Cl. G06K 9/00; G06F 3/041

(52) U.S. Cl. CPC G06K 9/00013; G06F 3/0416; G06F 2203/04106

(57) ABSTRACT

An electronic device, a controlling method thereof and a manufacturing method thereof are provided. The electronic device includes a substrate, a touch sensing circuit, a fingerprint identification module, a detection circuit and a processing unit. The touch sensing circuit is disposed on the substrate. The fingerprint identification module is disposed on the substrate. The detection circuit is disposed on the substrate. The detection circuit surrounds the fingerprint identification module to detect a sensing signal of a finger. The processing unit controls the fingerprint identification module according to the sensing signal.

This application claims the benefit of Taiwan application Serial No. 105111256, filed Apr. 11, 2016, the subject matter of which is incorporated herein by reference.

### BACKGROUND OF THE INVENTION

### Field of the Invention

The invention relates in general to an electronic device, a controlling method thereof and a manufacturing method thereof, and more particularly to an electronic device having a fingerprint identification module, a controlling method thereof and a manufacturing method thereof.

### Description of the Related Art

Along with the advance in technology, various types of electronic device are provided one after another. As the function of the electronic device is augmented, the risk of personal information being stolen is getting higher and higher. To avoid personal information being stolen, many electronic devices are equipped with a fingerprint identification module. Through the fingerprint identification module, the user can set his/her fingerprint as a login password to avoid any unauthorized persons using the electronic device.

### SUMMARY OF THE INVENTION

The invention is directed to an electronic device, a controlling method thereof and a manufacturing method thereof. The touch sensing circuit and the fingerprint identification module are disposed on the same substrate, such that the design of lightweight, slimness, and compactness can be achieved. Furthermore, the operation of the fingerprint identification module can be managed through the detection circuit.

According to a first aspect of the present invention, an electronic device is provided. The electronic device includes a substrate, a touch sensing circuit, a fingerprint identification module, a detection circuit and a processing unit. The touch sensing circuit is disposed on the substrate. The fingerprint identification module is disposed on the substrate. The detection circuit is disposed on the substrate. The detection circuit surrounds the fingerprint identification module to detect a sensing signal of a finger. The processing unit controls the fingerprint identification module according to the sensing signal.

According to a second aspect of the present invention, a controlling method of an electronic device is provided. The electronic device includes a substrate, a touch sensing circuit, a fingerprint identification module, a detection circuit and a processing unit. The touch sensing circuit is disposed on the substrate. The fingerprint identification module is disposed on the substrate. The detection circuit is disposed on the substrate and surrounds the fingerprint identification module. The controlling method includes following steps: A sensing signal of a finger touch is detected by the detection circuit. The fingerprint identification module is controlled according to the sensing signal by the processing unit.

According to a third aspect of the present invention, a manufacturing method of an electronic device is provided. The manufacturing method of the electronic device includes following steps: A substrate is provided. A touch sensing circuit, a detection circuit and a plurality of conductive contacts are formed on the substrate. The detection circuit surrounds the conductive contacts. An anisotropic conductive film (ACF) is formed on the conductive contacts. A fingerprint identification module is formed on the anisotropic conductive film to electrically connect the conductive contacts.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an electronic device according to an embodiment.

FIG. 2 is a cross-sectional view of the electronic device of FIG. 1 along a cross-sectional line A-A′.

FIG. 3 is a schematic diagram of an electronic device according to another embodiment.

FIG. 4 is a schematic diagram of a detection unit.

FIG. 5 is a schematic diagram of a fingerprint identification module and a detection circuit according to an embodiment.

FIG. 6 is a schematic diagram of a fingerprint identification module and a detection circuit according to another embodiment.

FIG. 7 is a schematic diagram of a fingerprint identification module and a detection circuit according to another embodiment.

FIG. 8 is a schematic diagram of a fingerprint identification module and a detection circuit according to another embodiment.

FIG. 9 is a flowchart of a controlling method of an electronic device according to an embodiment.

FIG. 10 is a detailed flowchart of the step S120 of FIG. 9 according to an embodiment.

FIG. 11 is a detailed flowchart of the step S120 of FIG. 9 according to another embodiment.

FIG. 12 is a detailed flowchart of the step S120 of FIG. 9 according to another embodiment.

FIGS. 13A to 13D are schematic diagrams of a manufacturing method of electronic device according to an embodiment.

### DETAILED DESCRIPTION OF THE INVENTION

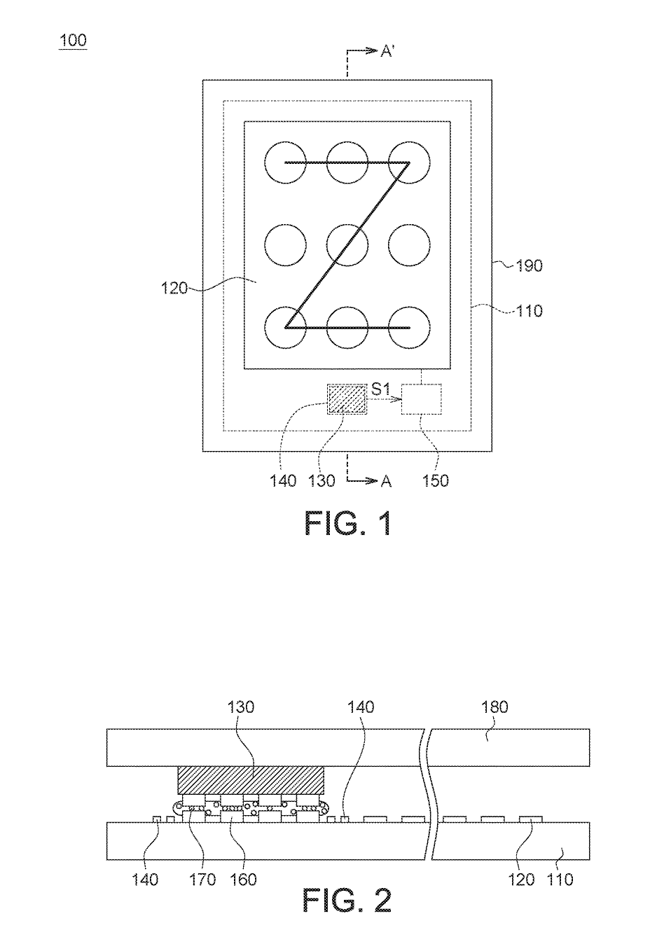

Refer to FIG. 1 and FIG. 2. FIG. 1 is a schematic diagram of an electronic device 100 according to an embodiment. FIG. 2 is a cross-sectional view of the electronic device 100 of FIG. 1 along a cross-sectional line A-A′. The electronic device 100 can be realized by such as a smartphone, a PC tablet, a touch screen, or a notebook computer. The electronic device 100 of FIG. 1 is exemplified by a smartphone. The electronic device 100 includes a substrate 110, a touch sensing circuit 120, a fingerprint identification module 130, a detection circuit 140, a processing unit 150 and a casing 190. The substrate 110, the fingerprint identification module 130, the detection circuit 140 and the processing unit 150 are all disposed inside the casing 190, and therefore are represented by dotted lines.

The fingerprint identification module 130 is used for identifying the fingerprint to increase the safety level of the electronic device 100. The touch sensing circuit 120 forms a touch panel (or touch board), which enables the user to perform touch operation in an intuitive manner. In the present embodiment, the touch sensing circuit 120 and the fingerprint identification module 130 are disposed on the same substrate 110. Thus, the touch sensing circuit 120 and the fingerprint identification module 130 can share the same connector and the same cable, such that the quantity of elements can be reduced and the design of lightweight, slimness, and compactness can be achieved.

The detection circuit 140 is disposed on the substrate 110. The detection circuit 140 surrounds the fingerprint identification module 130. Since the detection circuit 140 surrounds the fingerprint identification module 130, the detection circuit 140 will surely detect a finger and generate a sensing signal S1 when the finger touches the fingerprint identification module 130. Whether the fingerprint identification module 130 is operated or not can be obtained from the sensing signal S1.

The processing unit 150 can control the fingerprint identification module 130 according to the sensing signal S1. The processing unit 150 can be realized by such as a chip, a firmware circuit, or a storage device storing several programming codes. For example, the processing unit 150 can manage the power mode, the identification method or the identification fineness of the fingerprint identification module 130 according to the sensing signal S1.

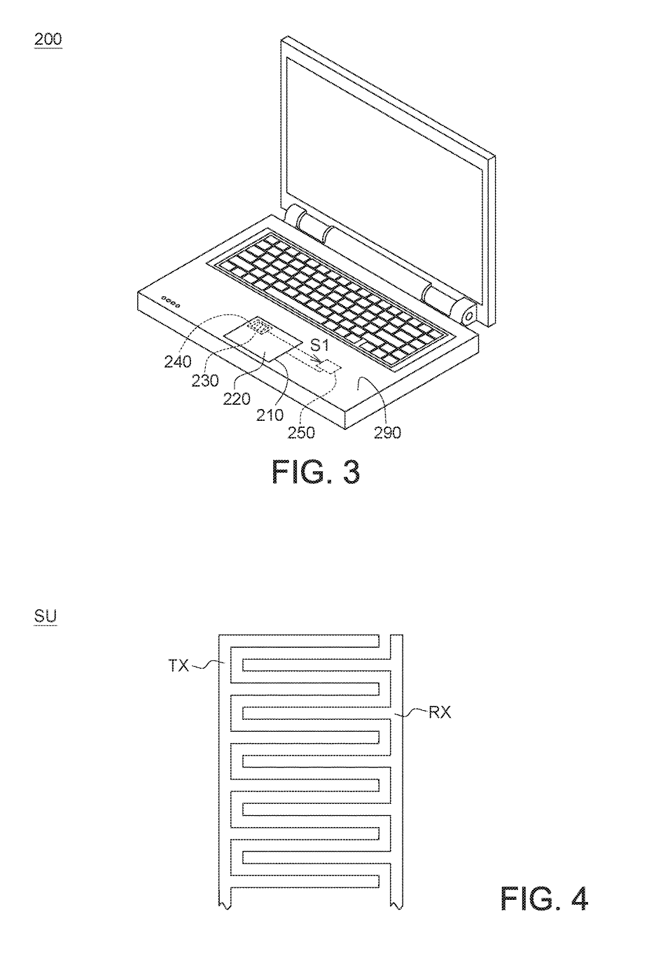

Referring to FIG. 3, a schematic diagram of an electronic device 200 according to another embodiment is shown. The electronic device 200 of FIG. 3 is exemplified by a notebook computer. The electronic device 200 includes a substrate 210, a touch sensing circuit 220, a fingerprint identification module 230, a detection circuit 240, a processing unit 250 and a casing 290. The fingerprint identification module 230, the detection circuit 240 and the processing unit 250 are all disposed inside the casing 290, and therefore are represented by dotted lines. The touch sensing circuit 220 forms a touch board through which the user can move a cursor or write a text. The substrate 210, the touch sensing circuit 220, the fingerprint identification module 230, the detection circuit 240 and the processing unit 250 of FIG. 3 are similar to the substrate 110, the touch sensing circuit 120, the fingerprint identification module 130, the detection circuit 140 and the processing unit 150 of FIG. 1, and the similarities are not repeated here.

Referring to FIG. 4, a schematic diagram of a detection unit SU is shown. The said detection circuits 140 and 240 can be formed of one or more than one detection unit. As indicated in FIG. 4, the detection unit SU can be realized by a finger-insertion type structure formed of a transmission circuit TX and a receiving circuit RX.

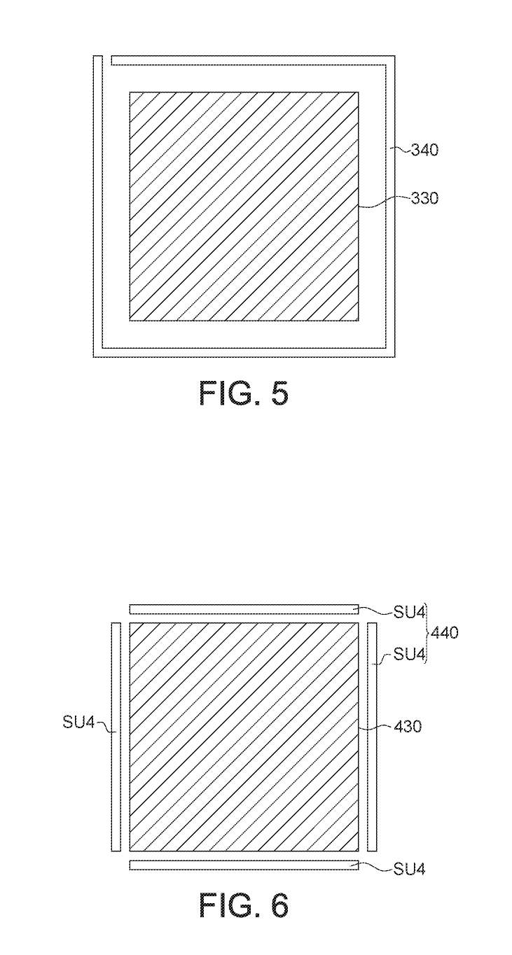

Various designs of the detection circuits 140 and 240 are further elaborated below. Referring to FIG. 5, a schematic diagram of a fingerprint identification module 330 and a detection circuit 340 according to an embodiment is shown. In the embodiment of FIG. 5, the detection circuit 340 substantially surrounds the fingerprint identification module 330. Thus, the finger can be detected regardless of the direction by which the finger approaches the fingerprint identification module 330.

Referring to FIG. 6, a schematic diagram of a fingerprint identification module 430 and a detection circuit 440 according to another embodiment is shown. In the embodiment of FIG. 6, the detection circuit 440 includes four detection units SU4 respectively located on the four lateral sides of the fingerprint identification module 430. Thus, which lateral side of the fingerprint identification module 430 is pressed by the finger can be accurately detected.

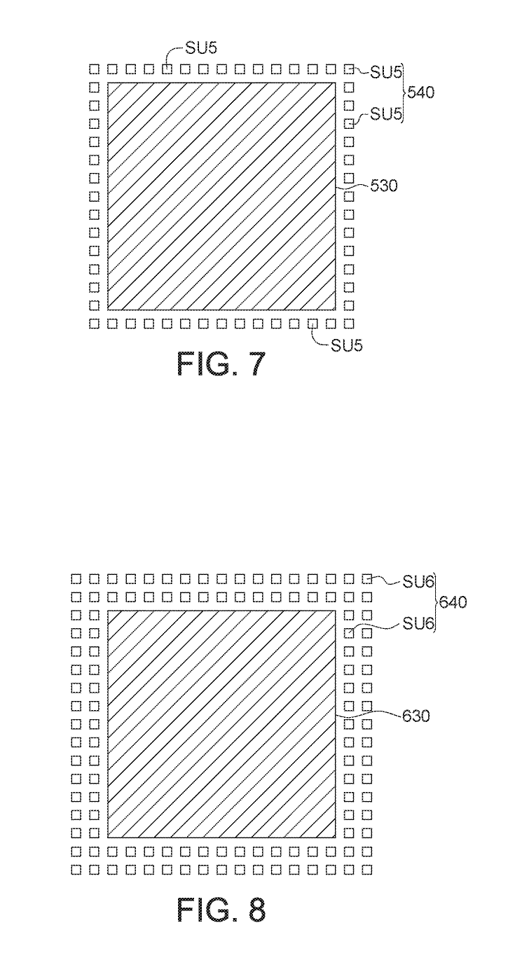

Referring to FIG. 7, a schematic diagram of a fingerprint identification module 530 and a detection circuit 540 according to another embodiment is shown. In the embodiment of FIG. 7, the detection circuit 540 includes a plurality of detection units SU5 surrounding the four lateral sides of the fingerprint identification module 530, and more than two detection units SU5 are disposed on one lateral side. Thus, the scope of each lateral side of the fingerprint identification module 530 pressed by the finger can be accurately detected.

Referring to FIG. 8, a schematic diagram of a fingerprint identification module 630 and a detection circuit 640 according to another embodiment is shown. In the embodiment of FIG. 8, the detection circuit 640 includes a plurality of detection units SU6. The detection units SU6 surround the fingerprint identification module 630 by two rings. Thus, the area of each lateral side of the fingerprint identification module 530 pressed by the finger can be accurately detected. In another embodiment, the detection units SU6 can also surround the fingerprint identification module 630 by more than two rings (such as three rings).

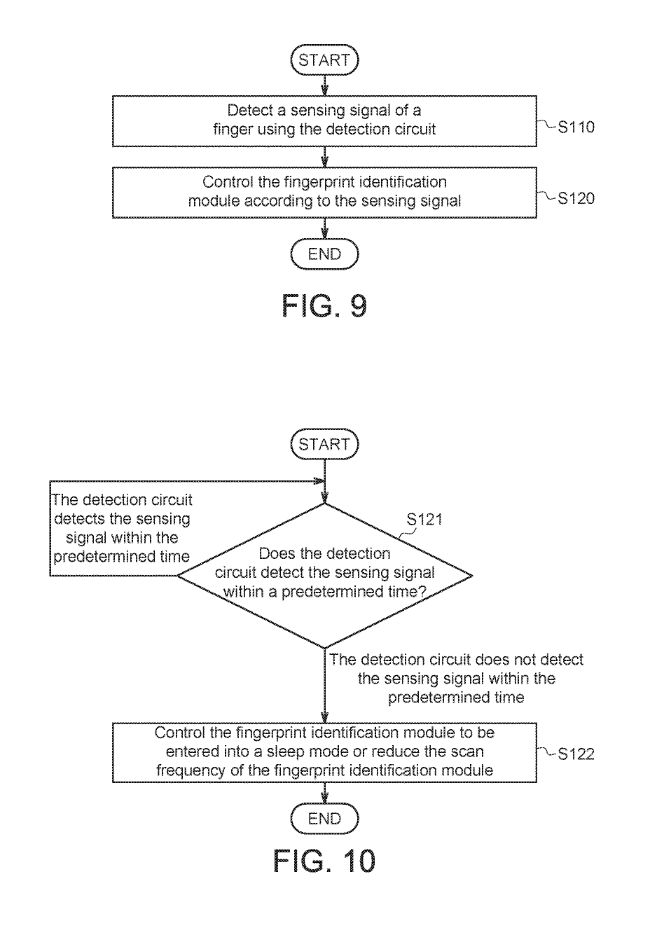

Various embodiments of fingerprint identification modules 330 to 630 and detection circuits 340 to 640 are disclosed in FIG. 5 to FIG. 8. The designer can select an appropriate design according to the requirements of the controlling method. Referring to FIG. 9, a flowchart of a controlling method of an electronic device according to an embodiment is shown. The flowchart of FIG. 9 is exemplified below using the electronic device 100 of FIG. 1. Firstly, the method begins at step S110, the sensing signal S1 of the finger is detected by the detection circuit 140. In the present step, the detection circuit 140 can detect the sensing signal S1 at a predetermined scan frequency, which can be equivalent to the scan frequency of the touch sensing circuit 120.

Next, the method proceeds to step S120, the fingerprint identification module 140 is controlled by the processing unit 150 according to the sensing signal S1. For example, the processing unit 150 can manage the power mode, the identification method or the identification fineness of according to the sensing signal S1. Various embodiments of step S120 are elaborated below

Referring to FIG. 10, a detailed flowchart of the step S120 of FIG. 9 according to an embodiment is shown. In step S121, whether the detection circuit 140 detects the sensing signal S1 within a predetermined time is determined by the processing unit 150. If the detection circuit 140 does not detect the sensing signal S1 within the predetermined time, then the method proceeds to step S122. If the detection circuit 140 detects the sensing signal S1 within the predetermined time, then the method proceeds to step S121. The predetermined time can be such as 2, 5, or 10 seconds. That is, if the fingerprint identification module 130 is not approached by any fingers within the predetermined time, then the method proceeds to step S122.

In step S122, the fingerprint identification module 130 is controlled by the processing unit 150 to be entered into a sleep mode or the scan frequency of the fingerprint identification module 130 is controlled to be reduced. Thus, when the fingerprint identification module 130 is not in use, power loss can be reduced.

In the embodiment of FIG. 10, the method needs to detect whether any fingers approach the fingerprint identification module 130, and is applicable to the embodiments of FIGS. 5 to 8.

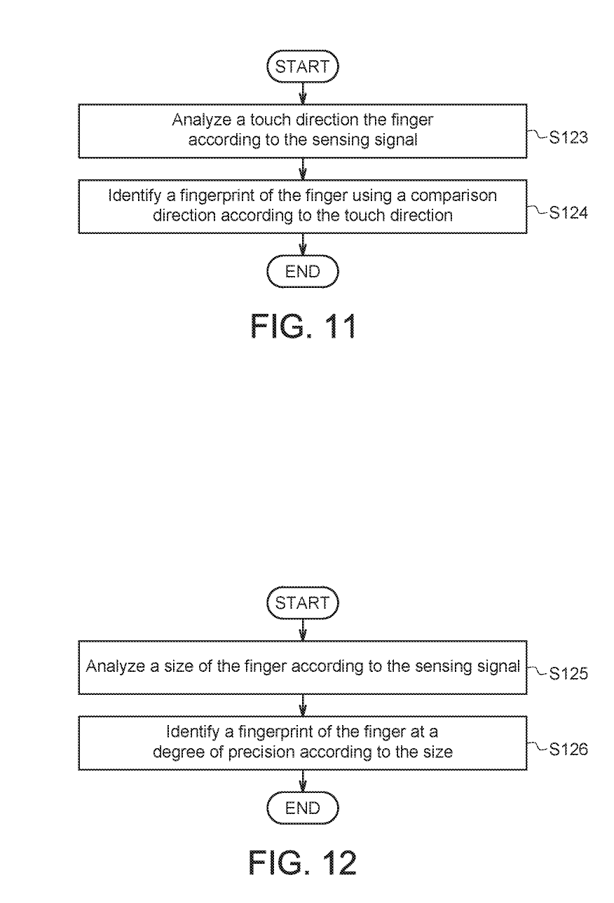

Referring to FIG. 11, a detailed flowchart of the step S120 of FIG. 9 according to another embodiment is shown. In step S123, a touch direction of the finger is analyzed by the processing unit 150 according to the sensing signal S1. Let the embodiment of FIG. 6 be taken for example. When the sensing signal S1 shows that the left side and the right side of the detection unit SU4 have been touched, this implies that the touch direction of the finger is a horizontal direction. When the sensing signal S1 shows that the top and the bottom of the detection unit SU4 have been touched, this implies that the touch direction of the finger is a vertical direction.

In step S124, a fingerprint of the finger is identified by the processing unit 150 using a comparison direction according to the touch direction. Thus, the processing unit 150 can directly identify the fingerprint using a correct comparison direction, not only largely reducing trials and errors but further largely increasing identification speed.

The method used in the embodiment of FIG. 11 needs to detect the touch direction of the finger, and is applicable to all embodiments of FIGS. 6 to 8.

Referring to FIG. 12, a detailed flowchart of the step S120 of FIG. 9 according to another embodiment is shown. In step S125, a size of the finger is analyzed by the processing unit 150 according to the sensing signal S1. Let the embodiment of FIG. 7 be taken for example. When the sensing signal S1 shows that the quantity of touched detection units SU5 is larger than a predetermined quantity, this implies that the finger has a large size. When the sensing signal S1 shows that the quantity of touched detection units SU5 is smaller than a predetermined quantity, this implies that the finger has a small size.

In step S126, a fingerprint of the finger is identified by the processing unit 150 at a degree of precision according to the size. For example, when the finger has a small size, this implies that this finger belongs to a child. Since the child's fingerprint is less evident, fingerprint identification needs to be performed at a higher degree of precision. When the finger has a size, this implies that this finger belongs to an adult. Since adult's fingerprint is more evident, fingerprint identification can be performed at a lower degree of precision. Thus, when identifying the child's fingerprint, the processing unit 150 can adopt a higher degree of precision to increase the precision of identification.

The method used in the embodiment of FIG. 12 needs to detect the finger's size, and is applicable to all embodiments of FIGS. 7 to 8.

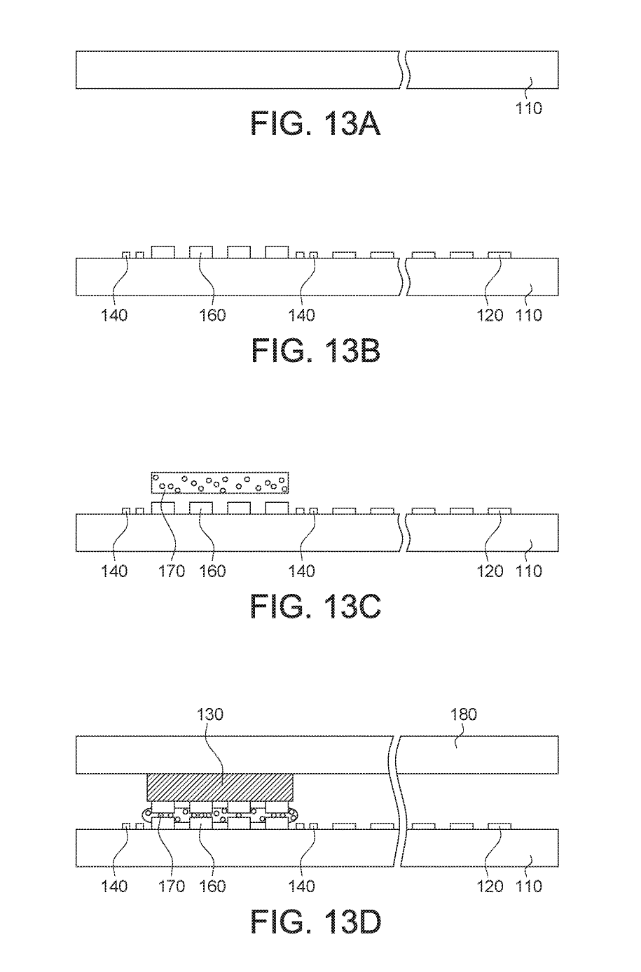

The operations of the fingerprint identification modules 140, 240, 340, 440, 540, and 640 can be assisted through various designs of the detection circuits 130, 230, 330, 430, 530, and 630. In an embodiment, the detection circuit 130, 230, 330, 430, 530 and 630 can be formed in the same manufacturing process with the touch sensing circuits 120 and 220. Referring to FIGS. 13A to 13D, schematic diagrams of a manufacturing method of electronic device according to an embodiment are shown. The manufacturing method of FIGS. 13A to 13D is exemplified using the electronic device 100 of FIG. 1. Firstly, as indicated in FIG. 13A, the substrate 110 is provided. Next, as indicated in FIG. 13B, the touch sensing circuit 120, the detection circuit 140 and a plurality of conductive contacts 160 are formed on the substrate 110. The detection circuit 140 surrounds the conductive contacts 160. The disposition of the detection circuit 140 can adopt the design of FIGS. 5 to 8.

In the present step, the detection circuit 140 and the touch sensing circuit 120 can be formed of the same material and are located on the same surface of the substrate 110. During the manufacturing process, the same mask and the same machine can be used, and the detection circuit 140 and the touch sensing circuit 120 can be concurrently formed in the same manufacturing process.

Then, as indicated in FIG. 130, an anisotropic conductive film (ACF) 170 is formed on the conductive contacts 160.

Then, as indicated in FIG. 13D, the fingerprint identification module 130 is formed on the anisotropic conductive film 170 to electrically connect the conductive contacts 160. In the present step, the fingerprint identification module 130 can be disposed on the protection board 180 in advance. Then, the anisotropic conductive film 170 can form a conductive channel in the vertical direction using a thermo-pressing process to electrically connect the fingerprint identification module 130 and the conductive contacts 160. Thus, the touch sensing circuit 120, the fingerprint identification module 130 and the detection circuit 140 can be smoothly disposed on the same substrate 110.

According to the electronic device and the controlling method and the manufacturing method thereof disclosed in above embodiments of the invention, the touch sensing circuit and the fingerprint identification module are disposed on the same substrate, so that the design of lightweight, slimness, and compactness can be achieved. Furthermore, the operation of the fingerprint identification module can be managed by the detection circuit.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device, comprising:
a substrate;
a touch sensing circuit disposed on the substrate;
a fingerprint identification module disposed on the substrate;
a detection circuit disposed on the substrate and surrounding the fingerprint identification module to detect a sensing signal of a finger; and
a processing unit used for controlling the fingerprint identification module according to the sensing signal.

2. The electronic device according to claim 1, wherein the detection circuit completely surrounds the fingerprint identification module.

3. The electronic device according to claim 1, wherein the detection circuit comprises a plurality of detection units.

4. The electronic device according to claim 3, wherein the detection units of the detection circuit surround the fingerprint identification module by more than two rings.

5. The electronic device according to claim 1, wherein the detection circuit and the touch sensing circuit are formed of the same material.

6. The electronic device according to claim 1, wherein the detection circuit and the touch sensing circuit are located on the same surface of the substrate.

7. The electronic device according to claim 1, wherein the processing unit determines whether the detection circuit does not detect the sensing signal within a predetermined time; if the detection circuit does not detect the sensing signal within the predetermined time, the processing unit controls the fingerprint identification module to be entered into a sleep mode or reduces a scan frequency of the fingerprint identification module.

8. The electronic device according to claim 1, wherein the processing unit analyzes a touch direction of the finger according to the sensing signal, and further identifies a fingerprint of the finger using a comparison direction according to the touch direction.

9. The electronic device according to claim 1, wherein the processing unit analyzes a size of the finger according to the sensing signal and further identifies a fingerprint of the finger at a degree of precision according to the size.

10. A controlling method of an electronic device, wherein the electronic device comprises a substrate, a touch sensing circuit, a fingerprint
identification module, a detection circuit and a processing unit, the touch sensing circuit is disposed on the substrate, the fingerprint identification module is disposed on the substrate, the detection circuit is disposed on the substrate and surrounds the fingerprint identification module, and the controlling method comprises:
detecting a sensing signal of a finger using the detection circuit; and
controlling the fingerprint identification module according to the sensing signal by the processing unit.

11. The controlling method of the electronic device according to claim 10,
wherein the step of controlling the fingerprint identification module according to the sensing signal comprises:
determining whether the detection circuit does not detect the sensing signal within a predetermined time by the processing unit; and
controlling the fingerprint identification module to be entered into a sleep mode or reducing a scan frequency of the fingerprint identification module by the processing unit, if the detection circuit does not detect the sensing signal within the predetermined time.

12. The controlling method of the electronic device according to claim 10, wherein the step of controlling the fingerprint identification module according to the sensing signal by the processing unit comprises:
analyzing a touch direction the finger according to the sensing signal by the processing unit; and
identifying a fingerprint of the finger using a comparison direction according to the touch direction by the processing unit.

13. The controlling method of the electronic device according to claim 10,
wherein the step of controlling the fingerprint identification module according to the sensing signal by the processing unit comprises:
analyzing a size of the finger according to the sensing signal by the processing unit; and
identifying a fingerprint of the finger at a degree of precision according to the size by the processing unit.

14. A manufacturing method of an electronic device, comprising:
providing a substrate;
forming a touch sensing circuit, a detection circuit and a plurality of conductive contacts on the substrate, wherein the detection circuit surrounds the conductive contacts;
forming an anisotropic conductive film (ACF) on the conductive contacts; and
disposing a fingerprint identification module on the anisotropic conductive film to electrically connect the conductive contacts.

15. The manufacturing method of the electronic device according to claim 14, wherein the detection circuit and the touch sensing circuit are formed in the same manufacturing process.
